(19) United States
(12) Patent Application Publication
(10) Pub. No.: US 2026/0029272 A1
(43) Pub. Date: Jan. 29, 2026

(54) SYSTEM WITH SENSORS AND EDGE ALGORITHMS FOR DETERMINING USAGE OF CONSUMABLE PRODUCTS

(71) Applicant: The Procter & Gamble Company, Cincinnati, OH (US)

(72) Inventors: Matthew Stephen BAUER, Loveland, OH (US); Cody Dylan LEWIS, Lawrenceburg, IN (US); Jonathan Livingston JOYCE, Crestview Hills, KY (US); Ye Ji PARK, Hesse (DE); Ankur Kumar CHOUDHARY, Frankfurt am Main (DE); Su Yon CHANG, Mason, OH (US)

(21) Appl. No.: 19/280,338

(22) Filed: Jul. 25, 2025

(30) Foreign Application Priority Data
Jul. 25, 2024 (CA) 3249827

(51) Int. Cl. G01G 17/04; G01D 21/02

(52) U.S. Cl. CPC G01G 17/04; G01D 21/02

(57) ABSTRACT

A system for determining usage of a consumable product includes a device assembly to receive the consumable product, and a server. The device assembly includes sensors to collect raw sensor data during sample time periods, and a controller to execute edge algorithms based on the collected raw sensor data. The edge algorithms summarize the raw sensor data collected during the sample time periods to single edge algorithm outputs. The server analyzes the single edge algorithm outputs to make a determination on the usage and consumption of the consumable product. To obtain a higher degree of confidence in performance of the edge algorithms, the server independently analyzes the raw sensor data. As refinements are made to the edge algorithms, the confidence of the edge algorithms is increased. Updated versions of the device assembly are simplified so that a minimal amount of raw sensor data is reported.

### FIELD

The present disclosure relates to systems, and, more specifically to a system with sensors and edge algorithms that is capable of detecting and reporting usage of consumable products by a consumer with a high degree of confidence.

### BACKGROUND

Manufacturers can benefit from information that indicates usage and consumption of consumable products. The consumable products may be dish care products, household cleaning products, laundry and fabric care products and personal cleaning products, for example.

One way for manufacturers to obtain usage and consumption information of these consumable products is by conducting research studies, for example. However, such studies are typically ineffective because they provide usage and consumption information during a particular point in time rather than over a long period of time that can better indicate actual usage and consumption. Moreover, consumer feedback on usage and consumption of the product may not be accurate when compared to actual usage and consumption.

A system for obtaining consumption information is provided by U.S. Pat. No. 11,403,651. The system includes a device for receiving a consumer product, wherein the device includes a sensor module for sensing a weight of the consumer product corresponding to use of the consumer product. The sensor module includes a time sensor to observe the time at which the consumer product is used, and generates time consumed data based on the observed time. A communication module is in communication with the sensor module, and is configured to wirelessly transmit data about the use of the consumer product based on the sensed weight changes in the consumer product. Nonetheless, there is still a need to improve upon such a system that collects and reports usage and consumption information of a consumable product, particularly with respect to having a high degree of confidence in the reported information.

The discussion of shortcomings and needs existing in the field prior to the present disclosure is in no way an admission that such shortcomings and needs were recognized by those skilled in the art prior to the present disclosure.

### SUMMARY

The systems, devices and methods of the present disclosure may be useful for determining usage of consumable products by a consumer with a high degree of confidence in the received data. A device assembly may be configured to receive a consumable product positioned thereon. The device assembly may include sensors to collect raw sensor data during sample time periods and may include a controller to execute edge algorithms that may be based on the collected raw sensor data. The edge algorithms may summarize the raw sensor data collected during the sample time periods to single edge algorithm outputs. A server may analyze the single edge algorithm outputs and may make a determination on the usage and consumption of the consumable product. To obtain a higher degree of confidence in performance of the edge algorithms, the server may independently analyze the raw sensor data. As refinements may be made to the edge algorithms, the confidence of the edge algorithms may increase. Updated versions of the device assembly may be simplified so that a minimal amount of raw sensor data may be reported.

A system for determining usage of a consumable product may include the device assembly to receive the consumable product when placed thereon, and the server. The device assembly may include sensors to collect raw sensor data during sample time periods, where the raw sensor data may comprise a plurality of data points within each sample time period for each sensor. A controller may be coupled to the sensors and may be configured to execute edge algorithms based on the collected raw sensor data for each sample time period. Each edge algorithm may summarize the raw sensor data from at least one of the sensors as a single edge algorithm output. A communication module may be coupled to the controller and may be configured to transmit the raw sensor data and the single edge algorithm outputs for each sample time period.

The server may include a memory to store the raw sensor data and the single edge algorithm outputs for each sample time period. The server may also include a processor that may make a determination on the usage of the consumable product based on the single edge algorithm outputs for each sample time period. The processor may also analyze the raw sensor data for each sample time period to evaluate confidence of the single edge algorithm outputs.

The device assembly includes a power source that may be at least one of a replaceable battery, a rechargeable battery, and a power cord with an electrical plug. The device assembly may further include an antenna that may be configured to charge the rechargeable battery via capturing radio frequency (RF) signals from an ambient environment. The sensors may include at least one of a weight sensor, a temperature sensor and a battery sensor.

The raw sensor data that may be collected by the temperature sensor and the battery sensor may be used as indicators by the edge algorithms to determine if the raw sensor data collected by the weight sensor is to be discarded.

The edge algorithms may include at least one secondary edge algorithm that may assess statistical variances of the raw sensor data to determine if an error code is to be generated to create awareness of a problem.

Each of the edge algorithms may be configured to perform a mathematical calculation on the raw sensor data that may be received for each sample time period to generate one of the single edge algorithm outputs. The mathematical calculations may include at least one of determining a delta from a previous measurement, an average of measurements during the sample time period, and a sigma average that may be a standard deviation of a last measurement.

The edge algorithms may include at least one of a weight delta analysis model that may determine a change in weight of the consumable product from a previous measurement, a weight average model that may determine an average of the weight measurements during each sample time period, a sigma weight average model that may determine a standard deviation of a last measurement, and a tare weight model that may determine a weight value when the consumable product is removed from the device assembly.

The sensors may further include a motion sensor, and the edge algorithms may further include a motion threshold model that may determine if a motion limit value of the device assembly has been exceeded.

The server may be configured to send updates to the edge algorithms that may be based on the analyzed raw sensor data to improve confidence of the single edge algorithm outputs.

The device assembly may include at least one memory with first and second memory sections, with the first memory sections that may store the edge algorithms and the second memory sections that may store the updated edge algorithms. The controller may be further configured to verify operation of the updated edge algorithms in the second memory sections before using the updated edge algorithms.

The system may further include a gateway that may receive the raw sensor data and the single edge algorithm outputs from the device assembly and may transmit the received raw sensor data and the single edge algorithm outputs to the server.

The device assembly may further include a communication module that may be configured to transmit the raw sensor data and the single edge algorithm outputs directly to the server.

The device assembly may be further configured to communicate with a client device that may comprise a survey app including pre-deployed survey questions, where the pre-deployed survey questions may be triggered by the device assembly in response to at least one of the edge algorithm outputs satisfying specific criteria, such as a weight change in the consumable product.

The server may be further configured to transmit at least one survey question to a client device in response to at least one of the edge algorithm outputs that may satisfy specific criteria, such as a weight change in the consumable product.

Another aspect may be directed to a device assembly as described above. The device assembly may include a housing having upper and lower edge sections with a transition section therebetween. The upper edge section may be recessed from the lower edge section. A bottom cover may be coupled to an underside of the housing. A top plate may extend over a topside of the housing and may overhang a portion of the transition section of the housing, with the top plate that may receive a consumable product and may be movable with respect to the housing. A weight sensor may be positioned within an interior of the housing and may contact the top plate for collecting weight measurements during sample time periods. A controller may be coupled to the weight sensor and may be configured to execute at least one edge algorithm that may be based on the collected weight measurements for each sample time period, with the at least one edge algorithm that may summarize the weight measurements as a single edge algorithm output for each sample time. A communication module may be coupled to the controller and may be configured to transmit the single edge algorithm output for each sample time period.

Another aspect may be directed to a method of determining usage of a consumable product with the above-described system. The method may include providing a device assembly. The device assembly may be operated to collect raw sensor data with the consumable product placed thereon during sample time periods. The raw sensor data may include a plurality of data points within each sample time period for each sensor. A plurality of edge algorithms may be executed based on the collected raw sensor data for each sample time period. Each edge algorithm may summarize the raw sensor data from at least one of the sensors as a single edge algorithm output. A communication module may be within the device assembly and may transmit the raw sensor data and the single edge algorithm outputs for each sample time period. The method may further include operating the server to store the raw sensor data and the single edge algorithm outputs for each sample time period. The single edge algorithm outputs for each sample time period may be analyzed to make a determination on the usage of the consumable product. The raw sensor data for each sample time period may be analyzed to evaluate confidence of the single edge algorithm outputs.

Another aspect may be directed to a method of prompting a consumer on a recommended sequence of use for a plurality of consumable products. The method may include providing a device assembly, where the device assembly may detect when a first consumable product is lifted off the device assembly indicating usage of the first consumable product. The device assembly may send a first message as part of usage sequence directions to a survey app on a client device which may provide directions to the consumer who may use a second consumable product after use of the first consumable product. The device assembly may receive sensor data from a sensor in a second consumable product which may indicate usage of the second consumable product by the consumer. The device assembly may send a second message as part of the usage sequence directions to the survey app on the client device which may provide directions to the consumer who may use a third consumable product after use of the second consumable product. The device assembly may receive sensor data from a sensor in the third consumable product which may indicate usage of the third consumable product by the consumer. The device assembly may send a survey request message to the survey app in the client device which may prompt the consumer to provide survey feedback on usage of the first, second and third consumable products.

Another aspect may be directed to a method of detecting conformance with a recommended sequence of use for a plurality of consumable products. The method may include providing a first device assembly. A first weight of a first consumable product package may be detected. The first consumable product package may include a first consumable product that may be positioned on the first device assembly. A first time at which the first consumable product package is lifted off the first device assembly may be detected that may indicate a usage of the first consumable product. A second time at which the first consumable product package is returned to the first device assembly may be detected. A second weight of the first consumable product package may be is detected. A first amount of the first consumable product consumed during the usage of the first consumable product may be calculated and may be based on the first weight and the second weight. The first amount may be compared to a first recommended usage amount for the first consumable product which may produce a first usage amount comparison.

A second device assembly may be provided. A third weight of a second consumable product package positioned on the second device assembly may be detected. The second consumable product package may include a second consumable product. A third time at which the second consumable product package is lifted off the second device assembly may be detected that may indicate a usage of the second consumable product. A fourth time at which the second consumable product package is returned to the second device assembly may be detected. A fourth weight of the second consumable product package may be detected. A second amount of the second consumable product consumed during the usage of the second consumable product may be calculated that may be based on the third weight and the fourth weight. The second amount may be compared to a second recommended usage amount for the second consumable product which may produce a second usage amount comparison.

The first time may be compared with the third time which may determine whether the first consumable product and the second consumable product were used according to a recommended sequence which may produce a sequence comparison. A workflow conformance analysis comprising the first usage amount comparison, the second usage amount comparison, and the sequence comparison may be reported.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures, which illustrate examples according to various embodiments.

FIG. 1 is a schematic diagram of a system that may include sensors and edge algorithms for determining usage of consumable products in which various aspects of the disclosure may be implemented.

FIG. 2 is a sequence of collecting weight measurements from the device assembly illustrated in FIG. 1.

FIG. 3 is a first dashboard screen shot of sensor data that may be analyzed by the cloud-based server illustrated in FIG. 1.

FIG. 4 is a second dashboard screen shot of sensor data that may be analyzed by the cloud-based server illustrated in FIG. 1.

FIG. 5 is an exploded view of the device assembly illustrated in FIG. 1.

FIG. 6 is a topside view of the printed circuit board illustrated in FIG. 1.

FIG. 7 is a cross-sectional view of the device assembly illustrated in FIG. 1.

FIG. 8 is a closeup view of the switch illustrated in FIG. 7 that may be mounted to the load plate.

FIG. 9 is a bottom perspective view of the device assembly illustrated in FIG. 1.

FIG. 10 is a bottom perspective view of the device assembly illustrated in FIG. 1 with the bottom cover removed.

FIG. 11 is a flowchart of a method that may determine usage of a consumable product with the system illustrated in FIG. 1.

FIG. 12 is a schematic diagram of the system illustrated in FIG. 1 that may be configured to prompt a consumer on a recommended sequence of use of consumable products.

FIG. 13 is a flowchart of a method that may prompt a consumer on a recommended sequence of use of consumable products with the system illustrated in FIG. 12.

FIG. 14 is a schematic diagram of the system illustrated in FIG. 1 that may be configured to detect conformance with a recommended sequence of use for consumable products.

FIGS. 15A-15B are a flowchart of a method that may detect conformance with a recommended sequence of use for consumable products with the system illustrated in FIG. 14.

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed may be one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequences where logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a sensor” includes a plurality of sensors. Particularly when a single countable noun is listed as an element in a claim, this specification will generally use a phrase such as “a single.” For example, “a single edge algorithm output.”

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Disposed on” or “carried by” may refer to a positional state indicating that one object or material is arranged in a position adjacent to the position of another object or material. The term does not require or exclude the presence of intervening objects, materials, or layers.

“Module” may refer to software instructions and codes to perform a designated task or a function. A module may be a software module or a hardware module. A software module may include one or more software routines. A hardware module may be a self-contained component with an independent circuitry that may perform various operations described herein.

“Controller” may refer to a computing context and may be a hardware device or a software program that may manage or direct the flow of data between two entities. In general, a controller may include a processor to interface between two or more devices and may manage communications between them.

“Edge algorithm” refers to a computational process or set of rules designed to run on edge devices, which are computing units located at the periphery of a network, closer to the source of data generation rather than in centralized cloud data centers. Edge algorithms, used according to various embodiments, may be optimized for low latency, efficient power consumption, and minimal data transmission requirements. These algorithms may often involve real-time data processing, decision-making, and actuation to support various applications such as determining usage of consumable products. Edge algorithms may comprise one or more programmatic models, and the edge algorithm itself may be referred to as a model. Each edge algorithm may be iteratively trained or derived based on the raw sensor data received by that algorithm during a sample time period.

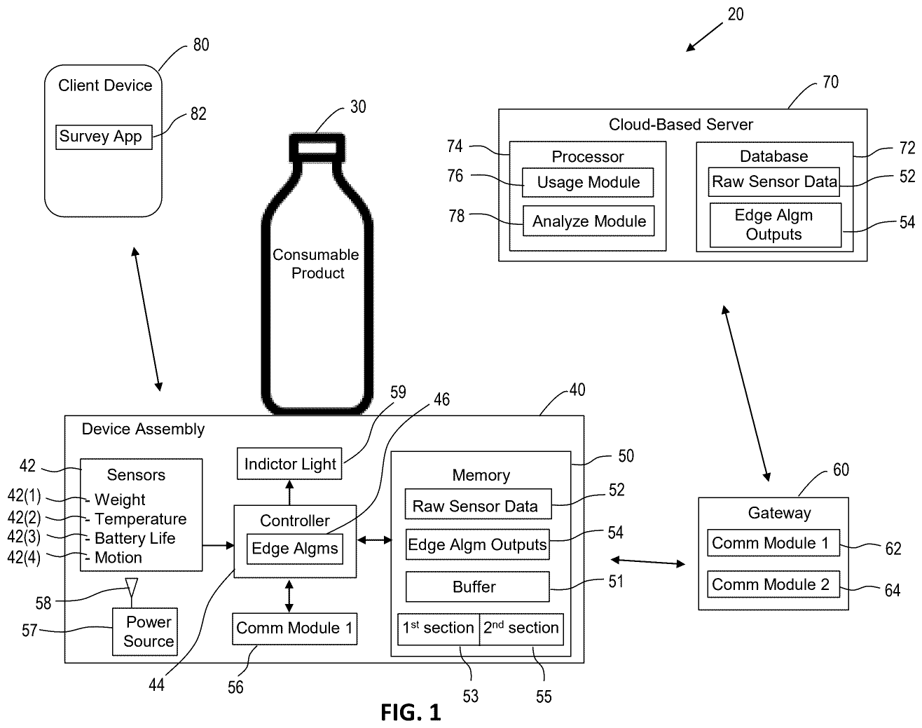

Referring initially to FIG. 1, a system 20 that may include sensors 42 and edge algorithms 46 that may be used for determining usage of consumable products 30 by a consumer with a high degree of confidence will be discussed. The consumer may be one of many consumers participating in a marketing survey that may be conducted by manufacturers of the consumable products 30.

The consumable products 30, for example, may be dish care products, household cleaning products, air fresheners, laundry care products, fabric care products, personal cleaning products, personal grooming products, nutritional products, and the like. Information on usage and consumption of a consumable product 30 may advantageously be used by a manufacturer of the consumable product 30. Qualitative information may be obtained when consumer sentiment matches up with actual usage of the consumable product 30.

The system 20 may include a device assembly 40, a gateway 60, and a cloud-based server 70. The device assembly 40 may receive a consumable product 30 placed thereon, and the gateway 60 may be close proximity to the device assembly 40. The device assembly 40 and the gateway 60 may be placed in the consumer's residence. The gateway 60 may plug into an electrical output for power, and the device assembly 40 may include a power source 57. The power source 57 may be, for example, a replaceable battery, a rechargeable battery, or a power cord with an electrical plug. The device assembly 40 may further include an antenna 58 that may be configured to charge the rechargeable battery via capturing radio frequency (RF) signals from an ambient environment. The gateway 60 may relay communications that may be exchanged between the device assembly 40 and the cloud-based server 70, and vice-versa.

The device assembly 40 may include one or more sensors 42, and a controller 44 that may be coupled to the one or more sensors 42. The sensors 42 may collect raw sensor data during sample time periods. The raw sensor data may also be referred to as data points. A sample time period may be between 5-10 seconds, for example, where 50-100 data points are collected at a 10 Hz sampling rate.

The controller 44 may be configured to execute a plurality of edge algorithms 46, as will be discussed in greater detail below. The edge algorithms 46 may summarize the raw sensor data (i.e., data points) 52 that may be collected during each sample time period to one or more single data point outputs. Each of the single data outputs may represent a summary of one or more raw sensor data points. For example, the 50-100 data points that may be collected by a sensor 42 may be summarized as a single data point output. The one or more single data point outputs may be referred to as edge algorithm outputs 54.

The use of edge algorithms 46 may allow a large number of data points which may be collected by the sensors 42 during the sample time periods. By summarizing the data points that may be done by averaging or determining a standard deviation, only one summary data point may be output during each sample time period for an edge algorithm 46. The edge algorithms 46 may not be processor intensive nor may they take up much memory space, both of which are limited on a battery-operated device assembly 40.

The controller 44 may further be configured to execute one or more algorithms addressing hysteresis. Scales may generally not be configured for constant loading. Additionally, scales may generally not be designed for accurate measurement of removed weight after extended loading times. So, as an example where an initial weight of a consumable product 30 may have an initial weight of 100 grams, after use, the weight of the consumable product may be 70 grams. However, because the scale was loaded for an extended period of time, it may provide data that shows that the weight of the consumable product may be 60 grams after use, and further, if multiple placement and removal events happen in quick succession, each replacement weight event may have significant variance from true mass. Algorithms may be executed by the controller 44 which may alleviate hysteresis of the device assembly 40 of the present disclosure. Because of the unique use of the device assembly 40 of the present disclosure, calibration may be of importance. Calibration of the device assembly 40 of the present disclosure may take into account the gradual unloading of the device. Specifically, as the consumable product 30 being measured is consumed, less weight may be provided on the device assembly 40. Calibration of conventional load cells is designed for loading from zero applications which may result in hysteresis of the device assembly 40 while unloading.

The cloud-based server 70 may be configured to receive, via the gateway 60, the raw sensor data 52 that may be collected during each sample time period, and the corresponding edge algorithm outputs 54 may summarize the raw sensor data 54. The raw sensor data 52 and the edge algorithm outputs 54 may be stored in a database 72 within the cloud-based server 70. A processor 74 within the cloud-based server 70 may include a usage module 76 that may make determinations on the usage and consumption of the consumable product 30 that may be based on the edge algorithm outputs 54.

The processor 74 may also include an analyze module 78 that may independently analyze the raw sensor data 52. The analyze module 78 may operate in an iterative model training mode which may evaluate performance of the edge algorithms 46 in view of the raw sensor data 52. Even though the cloud-based server 70 is illustrated with a single processor 74, typically there may be multiple processors that may perform the functions of the usage module 76 and the analyze module 78.

There is an advantage of the analyze module 78 to independently analyze the raw sensor data 52 since there may be uncertainty on the trustworthiness of the edge algorithm outputs 54. This may be a result of the edge algorithms 46 being initially trained with raw sensor data 52 that may not yet have been processed by the edge algorithms 46.

To address this uncertainty, the processor 74 may independently analyze the raw sensor data 52 which may serve as a continuous feedback loop. This feedback loop advantageously allows performance of the edge algorithms 46 to be evaluated. The objective may be to collect enough raw sensor data from enough situations to see all the ways that the edge algorithms 46 may fail. If improvements can be made to the edge algorithms 46, then the cloud-based server 70 may then send updates to the edge algorithms 46 via the gateway 60 which in turn may increase confidence in the edge algorithm outputs 54.

After a sufficient number of iterative refinements have been made to the edge algorithms 46, then the confidence of the edge algorithm outputs 54 may be considered to be very high. Consequently, there may be less of a need to continue to evaluate the raw sensor data 52 independently. Updated versions of the device assembly 40 may be simplified so that a minimal amount of data may be reported. The minimal amount of data may be weight measurements of the consumable product 30 and a standard deviation of the weight measurements. Thus, updated versions of the device assembly 40 might include a simplified weight difference edge model that simply reports a difference between measured weights, and/or an anomaly edge algorithm, where the anomaly edge algorithm may indicate that the weight difference data should not be trusted. However, the device assembly 40 may still have the capability to execute the other edge algorithms and report more raw sensor data if requested by the cloud-based server 70. The device assembly 40 may receive an enter raw sensor data transmit mode command. The cloud-based server 70 may be configured to remotely activate this feature of the device assembly 40 if desired.

The creation of an edge algorithm 46 may require raw sensor data 52 that have not yet been processed by the edge algorithm 46, and data labels that may enable one to train a math model or derive an algorithm which isolates or extracts the knowledge features of interest. Data labels may be markers of ground truth on specific time points of the raw sensor data 52.

As an example, a weight sensor 42(1) may at times indicate a weight change. With the ground truth labels, the developers of the system 20 may determine that some of the weight changes are based on real usage of the consumable product 30, and at other times are not. The developers may then train a math model to recognize the distinctive differences between usage and noise.

Each edge algorithm 46 may also be referred to as a model, and may be trained or derived to perform a mathematical-type calculation that may be based on the raw sensor data 52 received by that algorithm during the sample time period. Example mathematical type calculations may include, for example, determining a delta from a previous measurement, an average of the measurements during the sample time period, or a sigma average which is a standard deviation of the last measurement.

Training the edge algorithms 46 may require an iterative refinement since the corresponding models may not be accurate under all the possible situations to which the device assembly 40 may be subjected. On an initial release of an edge algorithm 46, it may be impractical for the developers to collect enough raw sensor data 52 from enough situations to see all the ways that a model may fail. Thus, part of the process of deploying an edge algorithm is for developers to study ways that the model fails the first time, and then improve or refine the edge algorithm or the models that make it up based on knowledge gleaned be collecting a large amount of additional supporting information.

By continuing to collect the supporting information on an ongoing basis (i.e., as a feedback loop), this may advantageously be used to indicate when a model should not be trusted. For the developers to have a release cycle where performance of the edge algorithms 46 may be continually improved over time, then the developers may try to build in features that repeat the original training of the model in different situations that may be encountered in the future.

The illustrated sensors 42 may include the weight sensor 42(1), a temperature sensor 42(2), and a battery life sensor 42(3). Optionally, a motion sensor 42(4) may be included which may determine acceleration and orientation of the device assembly 40. The motion sensor 42(4) may include at least one of an orientation sensor and an accelerometer. Weight data that may be collected during movement of the device assembly 40 may be discarded or flagged with an error code, and weight data collected while the device assembly 40 is on an incline may also be discarded or flagged with an error code. The one or more sensors 42(1)-42(4) may be generally referred to as sensors 42. The sensors 42 may provide the raw sensor data 52 to the controller 44 during the sample time periods.

The edge algorithms 46 may include a number of different type algorithms. A weight delta analysis algorithm may be used to determine a weight change from a previous weight measurement. A weight average algorithm may be used to average X weight measurements over X sample time periods. A sigma weight average algorithm may determine a standard deviation of the last measurement. A tare weight algorithm may provide a collection of sensor values when zero weight is on the weight sensor 42(1). A sigma tare weight algorithm may determine a standard deviation of the last tare measurement. A motion threshold model may determine if a motion limit threshold has been exceeded, as determined by the motion sensor 42(4).

Each edge algorithm 46 may receive the raw sensor data 52 over the sample period from at least one of the sensors 42 and may condense the raw sensor data (i.e., data points) 52 over the sample time period to a single edge algorithm output 54. A sample time period may be between 5-10 seconds, for example, where 50-100 data points are collected at a 10 Hz sampling rate. The number of data points that may be collected during the sample time period can be increased by increasing the sampling rate.

A sample time period may be initiated a number of different ways. One way to initiate the sample time period may be for the device assembly 40 to wake up in response to the consumable product 30 that may be lifted off the device assembly 40 or may be moved relative to the device assembly 40. Another way to initiate the sample time period may be for the device assembly 40 to initiate a timed wakeup. This may occur every 5 minutes, for example. Yet another way to initiate the sample time period may be for the motion sensor 42(4) to detect that the device assembly 40 is being moved. The edge algorithms 46 may include a motion threshold model that may be used to determine if the motion limit threshold value of the device assembly 40 has been exceeded. The device assembly 40 may also report how the sample time periods were initiated, which may be received by the cloud-based server 70.

It is worth noting that for lighter weights, more frequent checks may be utilized. For example, the sample time period may occur every 3 minutes.

The edge algorithms 46 may run the raw sensor data 52 through a mathematical equation that may generate the respective single edge algorithm outputs 54. The mathematical equation may be, for example, as straightforward as determining a delta from a previous measurement, or an average of the measurements during the sample time period, or a sigma average which is a standard deviation of the last measurement. As another example, the edge algorithms 46 may be as complex as training a machine learning model that may receive the raw sensor data 52 over the sample time period and may predict the respective edge algorithm outputs 54.

The controller 44 may be coupled to a non-volatile memory 50 and may store the received raw sensor data 52 and the edge algorithm outputs 54 in the memory 50. The memory 50 may be a flash memory. The controller 44 may also provide the raw sensor data 52 and the edge algorithm outputs 54 to a communication module 56 which may be configured to transmit the raw sensor data 52 and the edge algorithm outputs 54 to a corresponding communication module 62 in the gateway 60.

The communication modules 56, 62 may operate based on a short-range wireless technology standard, such as Bluetooth. The gateway 60 may include a second communication module 64 that may be configured to relay the raw sensor data 52 and the edge algorithm outputs 54 to the cloud-based server 70. The second communication module 64 may be cellular-based.

There are a number of advantages of the device assembly 40 communicating with the gateway 60 using Bluetooth messages. One advantage may be that the battery life of the coaster assembly 40 is extended. Another advantage may be that the device assembly 40 can receive time references so that the clock in the device assembly 40 may be be reset to the current time. Otherwise, the clock would typically drift over time. Since the Bluetooth messages are time-stamped, this provides an accurate time reference to when the consumer is using the consumable product 30.

The device assembly 40 may communicate with the gateway 60 using any suitable communication protocol. Low power communication protocols may include Bluetooth, Bluetooth low energy, lora, thread, zigbee, and the like, and are preferable as they can extend battery life. Higher power communication protocols which may similarly be utilized are Wi-Fi and cellular. Where the device assembly 40 has the capability of being plugged into a wall outlet, any suitable communication protocol may be utilized. As an alternative to the communication modules 56, 62 being configured as Bluetooth modules, the communication modules 56, 62 may be configured as Wi-Fi modules. Wi-Fi is a wireless network protocol that may be commonly used for local area networking of devices and internet access, which may allow nearby digital devices to send and receive messages. Wi-Fi modules may commonly be used in the field of Internet of things (IoT).

The gateway 60 may also be able to provide updates from the cloud-based server 70 to the device assembly 40. For example, updates may be provided to the edge algorithms 46 which may increase the confidence of the edge algorithm outputs 54. The edge algorithms 46 may be stored in a first memory section 53 of the memory 50, whereas updates to the edge algorithms 46 may be stored in a second memory section 55 of the memory 50. The controller 44 may be configured to verify operation of the updated edge algorithms in the second memory section 55 before using the updated edge algorithms. As another example, the communication module 56 may receive at least one of over the air firmware updates from the cloud-based server 70, cloud functions, e.g., change of sample time intervals from 5 minutes to 10 minutes, and time clock updates.

The gateway 60 may also be able to provide commands from the cloud-based server 70 to the device assembly 40. The commands may include turning the device assembly 40 off, initiating recalibration or changing the calibration curve of the device assembly 40, or activate/deactivate software features within the device assembly 40.

The software features may be used to increase or decrease the amount of raw sensor data 52 that may be collected by the sensors 42 and may be processed by the edge algorithms 46. This may allow the device assembly 40 to be configured to operate in the iterative model training mode or in a trustworthy confidence mode. In the iterative model training mode, the raw sensor data 52 may be needed by the cloud-based server 70 to evaluate performance of the edge algorithm outputs 54. In the trustworthy confidence mode, a sufficient number of refinements may have been made to the edge algorithms 46 so that the raw sensor data 52 provided to the cloud-based server 70 may be significantly reduced.

The system 20 of the present disclosure may utilize cellular communication protocols. For example, the communication module 56 in the device assembly 40 may be replaced by the cellular communication module 64 in order to do away with the gateway 60 by communicating directly with the cloud-based server 70. The cellular communication module 64 may also be referred to as a SIM module. Doing away with the gateway 60 is a tradeoff on the device assembly 40 using more power to operate with the cellular communication module 64. Consequently, the batteries may need to be replaced more often, which may require reminders to be sent to the consumer to change the batteries. This in turn may increase the level of supervision needed during the marketing survey. Another tradeoff may be that transmitting cellular-based data may be more costly than transmitting Bluetooth messages.

The gateway 60 may be configured to plug into a wall socket. As such any suitable communication protocol may be utilized for communication between the gateway 60 and the cloud-based server 70. The gateway 60 may be any suitable device. Some examples may include smart phones, Oral-B powered toothbrushes that have communication capability, Apple® TV, and the like. It is worth noting that to utilize Apple® TV as the gateway, the communication protocol between the device(s) and the gateway 60 may need to be thread. If the device assembly 40 cannot establish communications with the gateway 60 or with the cloud-based server 70 when operating with a cellular communication module, then the raw sensor data 52 and the edge algorithm outputs 54 may be placed in a buffer 51 until communications is re-established. The buffer 51 may be a ring buffer, for example, that may reuse the memory when needed and may be pre-allocated so it may be ready to be used and may be written as soon as it is needed.

During the initial training of the edge algorithms 46, close attention may be paid to the raw sensor data 52 provided by sensors 42(2)-42(4) and to secondary edge algorithms 46 operating in the device assembly 40. The raw sensor data 52 that may be provided by sensors 42(2)-42(4) may be a good indicator of times when a first release of the edge algorithms 46 may fail or may produce bad information.

Good indicators of bad data may include temperature, battery life and motion. When the temperature changes rapidly, this may cause the weight sensor 42(1) to drift. When a battery fails, the weight sensor 42(1) may still operate but in a non-optimal voltage regime, ruining the calibration offset assumptions. When the device assembly 40 is moving, the weight sensor 42(1) may not measure accurately.

As an example, the device assembly 40 may require 5 volts and above to provide accurate data. Below 5 volts, the weight sensor 42(1), along with other components within the device assembly 40 may still operate; however, the data being obtained by the device assembly 40 may not have the reliability of data obtained at the appropriate voltage.

Temperature data collected by the temperature sensor 42(2) may be used to initiate recalibration of the weight sensor 41(1). Temperature changes associated with the device assembly 40 may cause the weight sensor 41(1) to drift which may lead to an error in the weight measurement. One or more of the edge algorithms 46 may be modeled to correlate drift of the weight sensor 41(1) to different temperature values. In response to the known temperature, recalibration of the weight sensor 42(1) may normalize the error out of the weight measurement based on the temperature. It is contemplated that when data anomalies are discovered, the cloud-based server 70 may send a prompt to the consumer asking for pictures and/or videos of the device assembly 40. For those instances where location, attitude (physical position of the device, e.g., tilted) of the device assembly 40 may be determined to be the culprit of data anomalies, the cloud-based server 70 may prompt the consumer to rectify the situation by moving the device assembly 40.

The controller 44 may be configured to use the secondary edge algorithms 46 to generate error codes. The secondary edge algorithms 46 may assess the statistical variance of a measurement, and may be used to throw error codes, thus creating awareness of a problem. For example, when the tare reference is collected, the individual data points may have a high standard deviation because the consumer was probably still dragging the consumable product 30 across the top of the device assembly 40 when a measurement was being made. An error code or flag may be generated by the controller 44 and reported to the cloud-based server 70 so that the corresponding edge algorithm outputs 46 may be considered as non-trustworthy.

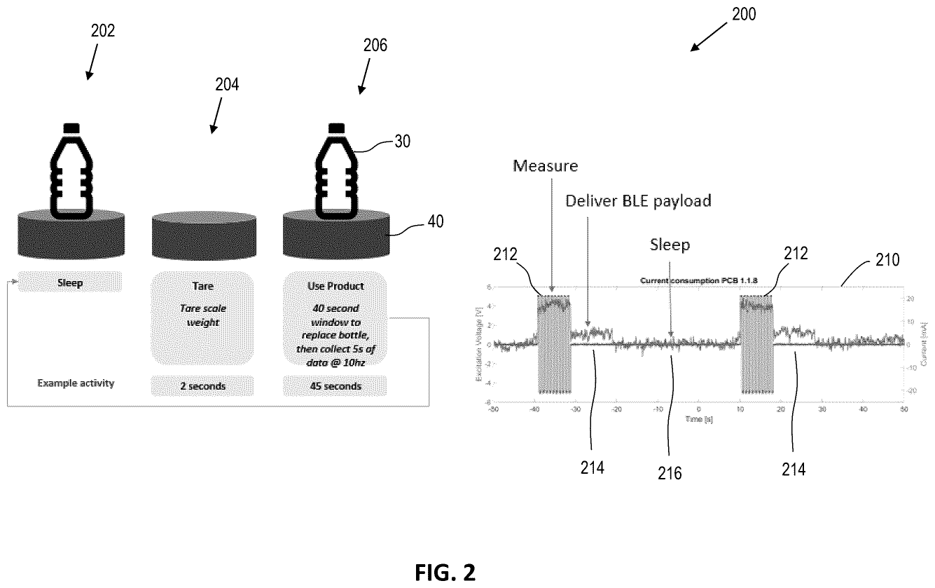

An example sequence 200 of collecting weight measurements will be discussed in reference to FIG. 2. At a first sequence 202, the device assembly 40 may be in a sleep mode and no sensor data 52 may be collected. At a second sequence 204, the device assembly 40 may wake up when the consumable product 30 is removed from the device assembly 40.

When the device assembly 30 first wakes up, any weight measurements that may be collected by the weight sensor 42(1) are set to zero. This is referred to as zeroing out the weight sensor 42(1) or performing a tare function. This may take about 2 seconds. When the weight sensor 42(1) is a load cell, for example, it may typically drift or creep over time, so setting the weight sensor 42(1) to a zero measurement without the consumable product 30 placed on the device assembly 40 may correct for any drift.

Between the second and third sequences 204 and 206, there may be about a 40 second window for the consumer to return the consumable product 30 back to the device assembly 40. At a third sequence 206, once the consumable product 30 is returned to the device assembly 40 after use by the consumer, then about 5 seconds of raw sensor data 52 may be collected.

In graph 210, example voltage and current consumption of the device assembly 40 may fluctuate during the different sequences. The voltage and current consumption during weight measurements may be high as indicated during time series 212. The voltage and current consumption of the weight measurements being delivered as a payload to the gateway 60 may be medium during time series 214. In between the weight measurements, the device assembly 40 may return back to the sleep mode during time series 216, where the voltage and current consumption may be low.

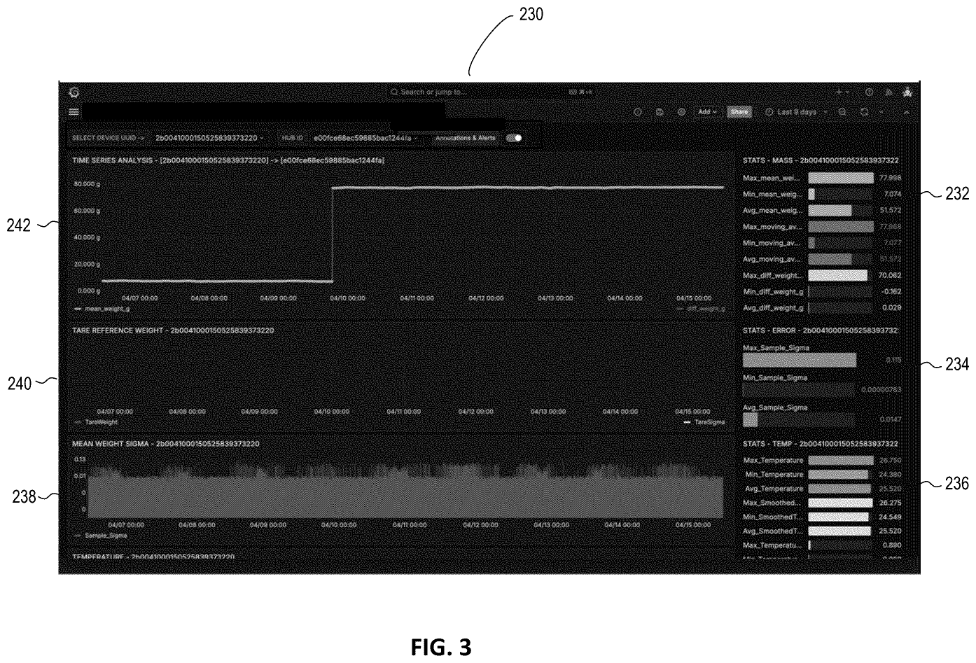

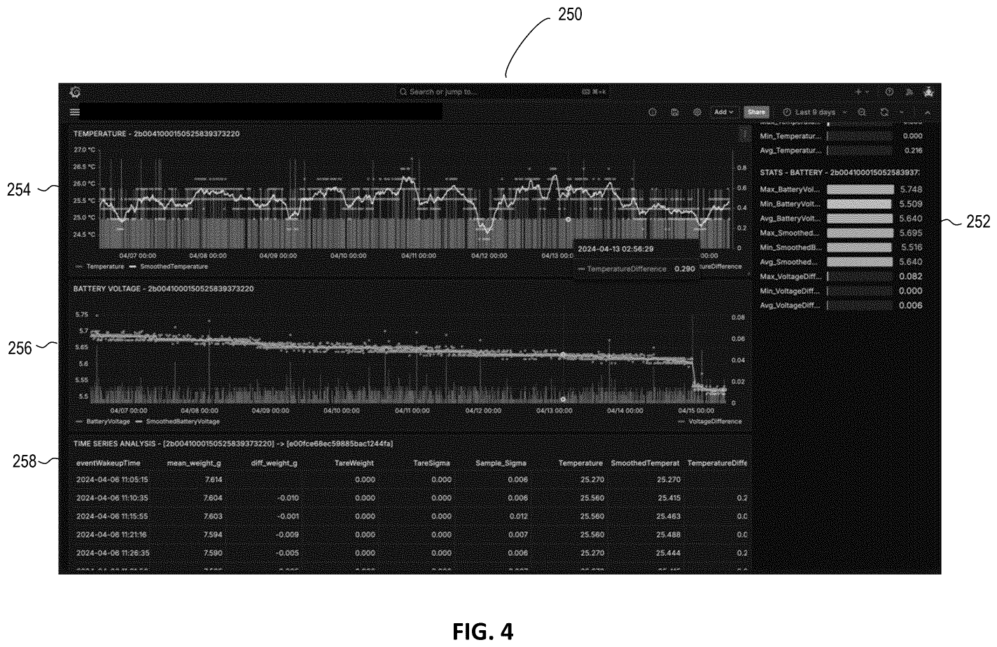

Referring now to FIGS. 3 and 4, dashboard screenshots 230, 250 may be provided to illustrate data analysis that may be performed by the cloud-based server 70 in order to train and refine the edge algorithms 46. The dashboard screenshots 230, 250 may provide statistics that may be generated by the cloud-based server 70 across a large time window of data. In this case, the time window of data being shown may be for multiple days.

This type of computation may be difficult to do on the device assembly 40 using the edge algorithms 46, but may be relatively straightforward for the cloud-based server 70. When an edge algorithm 46 is deployed, the edge data reported from the device assembly 40 may be much simpler since the raw sensor data 52 may be summarized as a single data point by the edge algorithm 46 for analysis by the usage module 76 in the cloud-based server 70. Power and memory in the device assembly 40 may be limited so the edge algorithms 46 need to be straightforward.

As reflected in the dashboard screenshots 230, 250, the analyze module 78 in the cloud-based server 70 may be analyzing all of the raw sensor data 52 collected by the sensors 42. In dashboard screenshot 230, mass stats 232, sigma stats 234 and temperature stats 236 may be provided. A time series 238 over multiple days may be provided for the mean weight sigma, a time series 240 over multiple days may be provided for the tare reference weight, and a time series 242 over multiple days may be provided for the mean weight.

In dashboard screenshot 250, battery stats 252 may be provided. A time series 254 over multiple days may be provided for the temperature, and a time series 256 over multiple days may be provided for the battery voltage. In addition, a summary chart 258 may also be provided to list out the different stat values every 5 seconds.

The implementation of edge algorithms 46 may have a number of uses. A first use may be for the transmission of less data by condensing the data points collected by a sensor 42 over a sample period to a single edge algorithm output 54. This may simplify the number of data points to be analyzed by the cloud-based server 70 to determine usage and consumption of the consumable product 30.

A second use of the edge algorithms 46 may be for the system 20 to provide a faster round-trip time to action, such as sending a usage triggered survey to the consumer after having just used the consumable product 30. Qualitative information may be obtained when consumer sentiment matches up with actual usage of the consumable product 30.

As part of the marketing survey being conducted by the manufacturer of the consumable product 30, a survey app 82 may be installed on the consumer's client device 80. The client device 80 may be a desktop computing device or a mobile computing device. A mobile computing device may include a cell phone or a personal display assistant (PDA), for example.

In a first scenario, the device assembly 40 may send the edge algorithm outputs 54 directly to the client device 80. The survey app 82 may have pre-deployed survey questions that may be triggered by specific criteria, such as a weight change in the consumable product 30. The survey app 82 may then make the decision to pop up the survey based on the received edge algorithm outputs 54 satisfying the specific criteria. This scenario may provide a faster round-trip time to action since initiation of the survey may not involve the cloud-based server 70. The turnaround time for the client device 80 to initiate the survey may be tens of seconds, for example. This may allow for an accurate emotional response from the consumer.

In a second scenario, which may provide a slower round-trip time to action, the cloud-based server 70 may feed the survey to the client device 80. The survey being provided by the cloud-based server 70 may not be pre-deployed as in the first scenario, which means the survey may ask for responses beyond the pre-deployed survey questions. This scenario may require the cloud-based server 70 to receive the edge algorithm outputs 54 from the device assembly 40, may parse the edge algorithm outputs 54, and may process the edge algorithm outputs 54 before making a decision to send the survey to the client device 80. This takes time, particularly if the cloud-based server 70 is made up of multiple servers that may require data to be passed from server to server before determining to send the survey to the client device 80. The turnaround time for the client device 80 to initiate the survey may be several minutes, for example, at which point the emotional response from the consumer may not be as accurate.

Regardless of whether the first scenario or second scenario are utilized, the survey may prompt the user to take one or more pictures/videos of the consumable product of interest and/or the space in which the consumable product of interest is being utilized. Additionally, the survey may ask for pictures/videos of the consumable product of interest in use.

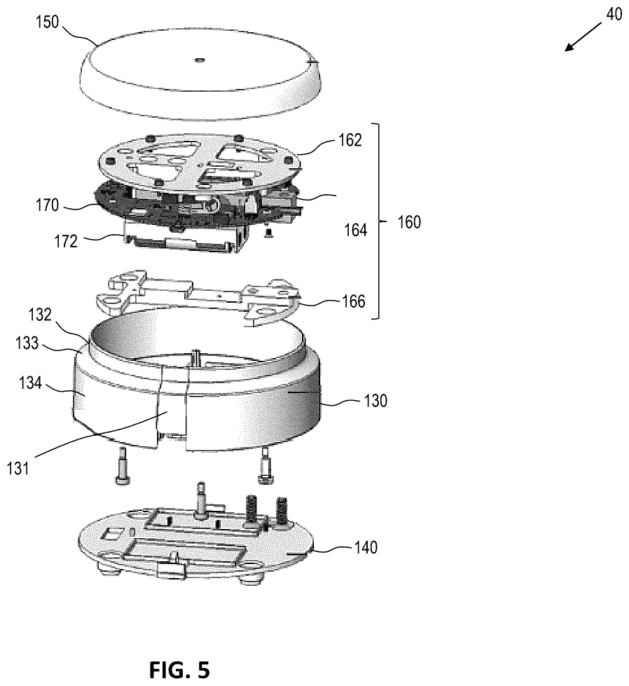

Referring now to FIG. 5, an exploded view of an exemplary device assembly 40 will be discussed. The illustrated device assembly 40 may be circular shaped, e.g., a coaster. This shape is not to be limiting as the device assembly 40 may have other shapes, such as an oval, a square or a rectangle, for example. The device assembly 40 may include a housing 130, a bottom cover 140, a top plate 150, and a load cell assembly 160 within an interior of the housing 130. The load cell assembly 160 may be one example of the weight sensor 42(1) as discussed above.

The load cell assembly 160 may comprise a load plate 162, a load cell 164 and a bottom plate 166 coupled together. The load plate 162 may be coupled to an under surface of the load cell 164, and the bottom plate 166 may be coupled to a lower surface of the load cell 164. The load cell 164 may be the only thing connecting the load plate 162 and the bottom plate 166. The load cell 164 may convert a force such as pressure into a signal that can be measured and standardized. The load cell 164 may also be referred to as a force transducer. As the force applied to the load cell 164 increases, the signal changes proportionally.

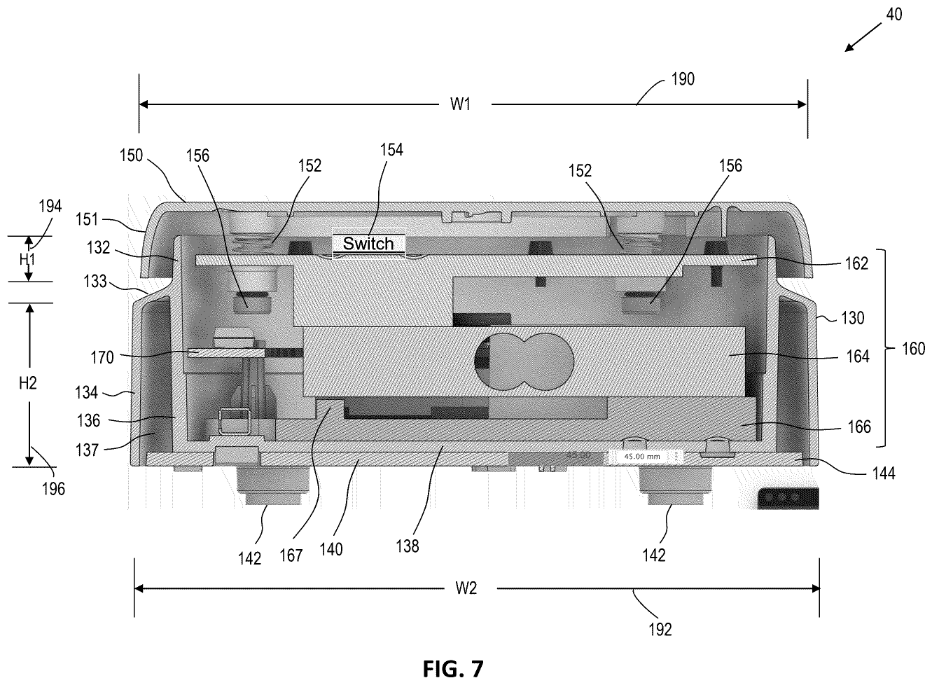

The top plate 150 may be coupled to the load plate 162 and may be movable with respect to the load plate 162. The top plate 150 may be spring-loaded 152 and a switch 154 may be positioned between the top plate 150 and the load plate 162 (see FIG. 7). When the consumable product 30 is placed on the device assembly 40, the top plate 150 may be pushed down against the springs and the switch. When the consumable product 30 is removed from the device assembly 40, the springs may push up against the top plate 150 which in turn may activate the switch to wake up the device assembly 30. The switch may be a pressure switch, pressure sensitive membrane, diaphragm switch, and the like. The switch may detect the removal and placement of the consumable product 30 onto the device assembly 40.

When the device assembly 40 first wakes up, any weight measurements collected by the load cell 164 may be set to zero. This is referred to as zeroing out the load cell 164 or performing a tare function. Load cells 164 may typically drift or creep over time, so setting the load cell 164 to a zero measurement without the consumable product 30 placed on the top plate 150 may correct for any drift.

When the consumable product 30 is returned to the top plate 150, then the load cell 164 may collect weight measurements of the consumable product 30. This may allow weight changes in the range of 0.25 grams to 1 gram to be detected. By subtracting a current measurement from a previous measurement, usage and consumption of the consumable product 30 may be determined.

A printed circuit board 170 may surround the load cell 164 and may be positioned between the load plate 162 and the bottom plate 166. A battery holder 172 may be electrically coupled to an underside of the printed circuit board 170. The printed circuit board 170 may be powered by batteries carried by the battery holder 172. The batteries may be AA batteries, for example. The bottom cover 140 may be removable to access the batteries. Other configurations are contemplated where the device assembly 40 may comprise a plugin power source or a rechargeable battery pack.

The housing 130 may have an upper edge section 132 and a lower edge section 134 and may include a transition section 133 therebetween. The upper edge section 132 may be recessed from the lower edge section 134. The bottom cover 140 may be coupled to an underside of the housing 130. The top plate 150 may extend over a topside of the housing 130 and may overhang a portion of the transition section 133.

The housing 130 may further comprise a removable housing side panel 131 which may expose a connector interface that may connect to the printed circuit board 170. The connector interface may be a USB or micro-USB interface, for example. After the device assembly 40 has been returned by the consumer, the connection interface may allow developers of the device assembly 40 to reprogram the edge algorithms 46 or download data stored on the printed circuit board 170.

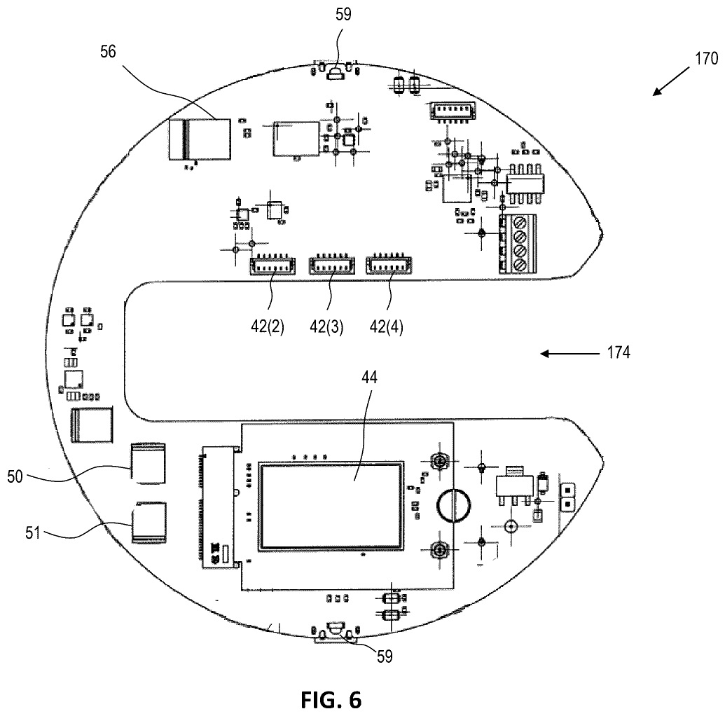

The printed circuit board 170 may be horseshoe-shaped or u-shaped, as illustrated in FIG. 6. The printed circuit board 170 may have an opening 174 that surrounds the load cell 164 when positioned within the housing 130. The electronic circuitry on the printed circuit board 170 may include the controller 44, the memory 50, the temperature sensor 42(2), the battery sensor 42(3), and the motion sensor 42(4).

The motion sensor 42(4) may be an attitude and heading reference system (AHRS) that may include three gyroscopes and three accelerometers for the x, y and z-axis. The motion sensor 42(4) may determine if the device assembly 40 is being moved or has been placed on an inclined surface, in which case any weight measurements collected by the load cell 164 may be discarded or flagged as an error code. The motion sensor 42(4) may also determine if the device assembly 40 has been dropped, in which case a recalibration of the load cell 164 may need to be performed.

The printed circuit board 170 may also include one or more indicator lights 59 to get the attention of the consumer currently using the consumable product 30. If the consumer is taking too long to return the consumable product 30 back to the device assembly 40, then the indicators lights 59 may be activated. As another example, the consumer may not correctly set the consumable product 30 back down on the device assembly 40, such as by sliding the consumable product 30 across the surface of the device assembly 40 when setting it down. Since this may result in a bad weight measurement, the indicator lights 59 may be activated so that the consumer will pick up the consumable product 30 and set it down again. As yet another example, the indicators lights 59 may be activated when power is low and the batteries need to be changed.

The indicator lights 59 may be activated without input from the cloud-based server 70. This activation may be within seconds which allows for a quicker reaction time by the consumer, particularly when the consumable product 30 needs to be returned to the top plate 150 or removed and returned to the top plate in a timely manner for the load cell 164 to obtain an accurate weight measurement. The alternative is for the device assembly 40 to report an anomaly to the gateway 60, which in turn may pass the anomaly to the cloud-based server 70. The cloud-based server 70 then may process the anomaly and may return a command to activate the indicator light 59. This may take several minutes before the indicator lights 59 may be activated, at which time it may be too late for the consumer to react accordingly.

The printed circuit board 170 may also include the communication module 56 for communicating with the gateway 60. The communication module 56 may include an antenna and transponder that may operate based on a short-range wireless technology standard, such as Bluetooth.

The communication module 56 may transmit the raw sensor data 52 and the edge algorithm outputs 54 to the gateway 60. The gateway 60 may then use a cellular communication module 64 which may transmit the raw sensor data 52 and the edge algorithm outputs 54 to the cloud-based server 70. The Bluetooth communication module 56 may draw less power than the cellular communication module 64 which may help to reduce power consumption of a battery-operated device assembly 40.

Nonetheless, the printed circuit board 170 may be configured to operate with a cellular communication module so that the raw sensor data 52 and the edge algorithm outputs 54 may be transmitted directly to the cloud-based server 70. The tradeoff will be increased power consumption of a battery-operated device assembly 40.

If the device assembly 40 cannot establish communications with the gateway 60 or with the cloud-based server 70 when operating with a cellular communication module, then the raw sensor data 52 and the edge algorithm outputs 54 may be placed in a buffer 51 until communications is re-established. The buffer 51 may be a ring buffer, for example, that may reuse the memory when needed and may be pre-allocated so it is ready to be used and can be written as soon as it is needed.

Referring now to FIG. 7, a cross-sectional view of the device assembly 40 will be discussed. The device assembly 40 may be configured to be water-resistant, which may be necessary when placed in a wet environment. For example, the device assembly 40 may be placed in the shower when the consumable product 30 is shampoo or conditioner.

The top plate 150 may extend over a topside of the housing 130 and may overhang a portion of the transition section 133. The top plate 150 may be flat with rounded edges so that water will run off. The transition section 133 of the housing 130 may be sloped upwards toward the upper edge section 132 so that the water will continue to drain away from the housing 130.

As noted previously, the housing 130 may have the upper edge section 132 and the lower edge section 134 with the transition section 133 therebetween. A height 194 of the upper edge section 132 may be less than a height 196 of the lower edge section 134. The height 194 of the upper edge section 132 and the height 196 of the lower edge section 134 may be separated by the transition section 133 which is sloped upwards from the lower edge section 134 to the upper edge section 132. This difference in height between the lower and upper edge sections 132, 134 may help to further prevent water from entering the interior of the housing 130 and contacting the printed circuit board 170. The height 194 of the upper edge section 132 may be about one-third to one-fourth the height 196 of the lower edge section 134. In addition, feet 142 may be placed on an underside of the bottom cover 140. The feet 142 may be sized to prevent water from entering the interior of the housing 140 when placed in a pool of standing water.

The bottom cover 140 may be removable to access the batteries 58. An outermost edge 144 of the bottom cover 140 may be recessed from the lower edge section 134 of the housing 130. In particular, the outermost edge 144 of the bottom cover 140 may extend into a gap 137 defined by the lower edge section 134 and an adjacent intermediate lower edge section 136. A bottom surface 138 of the housing 130 may extend between the intermediate lower edge sections 136.

As noted, the top plate 150 may extend over a topside of the housing 130 and overhang a portion of the transition section 133 of the housing 130. The side edge 151 of the top plate 150 may be recessed from the lower edge section 134 of the housing 130. The top plate 150 may have a width, as shown, e.g., a diameter 190. The housing 130 may have a width 192 when measured at the lower edge section 134. The width 192 may be the outer most width of the housing 130. The width 190 of the top plate 150 may be less than the width 192 of the housing 130. The difference in widths 190, 192 may be within a range of 0.125 inches to 0.375 inches. This range may vary based on the final size of the device assembly 40. Consequently, if the device assembly 40 comes in contact with an item placed next to it, contact may be made with the lower edge section 134 of the housing 130 and not the side edge 151 of the top plate 150. If contact was to be made with the side edge 151 of the top plate 150, then any weight measurements may not be accurate during contact with the item. In addition, a shape of the side edge 151 of the top plate 150 and a shape of the upper edge section 132 of the housing 130 may be proportionally concentric so that they do not rub against one another. Also, the side edge 151 of the top plate 150 may be sized so that a lower surface of the side edge 150 will not bottom out against the transition section 133 when the consumable product 30 is full.

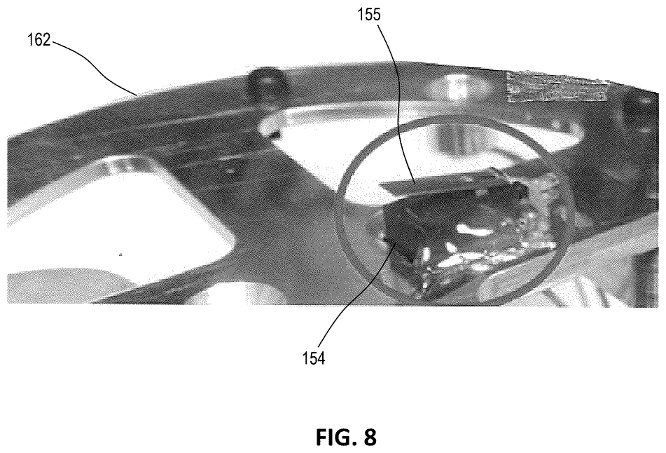

As noted above, the top plate 150 may be spring-loaded 152 and a switch 154 may be positioned between the top plate 150 and the load plate 162. The switch 154 may be configured as a micro-switch that may have an arm 155 that may protrude upwards and hit the underside of the top plate 150 (see FIG. 8). The springs 152 may be held in place using bolts 156 that may extend from an underside of the load plate 162 into the top plate 150 while still allowing the top plate 150 to move freely up and down.

When the consumable product 30 is placed on the top plate 150, the top plate 150 may be pushed down against the springs and may contact the arm 155 of the switch 154. When the consumable product 30 is removed from the device assembly 40, the springs may need to be strong enough to push the top plate 150 upwards so that it no longer makes contact with the arm 155 of the switch 154. There may be a balance between the strength of the springs 152 and a weight of the top plate 150 so that when the consumable product 30 approaches empty, the consumable product 30 can still push the top plate 150 down. As shown, since the height 194 of the upper edge section 132 may be significantly less than the height 196 of the lower edge section 134, less material may be used for the side edge 151 of the top plate 150. This may help in balancing between the weight of the top plate 150 and the strength of the springs 152.

As the springs 152 push the top plate 150 upwards after removal of the consumable product 30 so that contact is no longer made with the arm of the switch 154, the device assembly may wake up. Upon wakeup, any weight measurements collected by the load cell 164 may be set to zero. When the consumable product 30 is returned to the top plate 150, then weight measurements may be taken by the load cell 164.

A closeup view of the switch 154 and arm 155 are illustrated in FIG. 8. The switch may be mounted to the load plate 162, and the arm 155 may protrudes upwards. In such configurations, the arm 155 may hit the underside of the top plate 150 when a consumable product 30 is placed on the top plate 150. This is due to the springs 152 being pushed down by the weight of the consumable product 30. When the consumable product 30 is removed from the top plate 150, then the springs 152 may push the top plate 150 upwards so that the top plate 150 no longer makes contact with the arm 155 of the switch 154. The device assembly 40 may then wake up in response to the arm 155 no longer contacting the underside of the top plate 150.

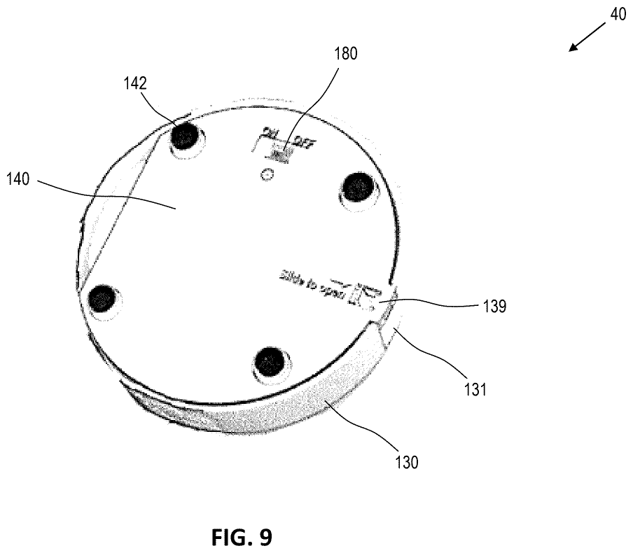

A bottom perspective view of the device assembly 40 is illustrated in FIG. 9. An on/off switch 180 may be accessible on an underside of the device assembly 40. Feet 142 may extend outwards from the bottom cover 140, where the feet 142 may elevate the housing 140 to prevent water from entering the interior of the housing 140 when placed in a pool of standing water. Any suitable height for the feet 142 may be utilized. For example, the feet 142 may have a height of from about 2 mm to about 20 mm, preferably from about 3 mm to about 15 mm, more preferably from about 4 mm to about 10 mm, or even more preferably from about 4 mm to about 7 mm. It is believed that the higher the feet 142 are, the more obtrusive the device assembly 40 becomes and will be less likely to be utilized by consumers.

The removable housing side panel 131 may include a flexible extension lever 137 that is exposed through an opening in the bottom cover 140. The flexible extension lever 137 may also engage the bottom cover 140 while in a locked position to hold the bottom cover 140 in place.

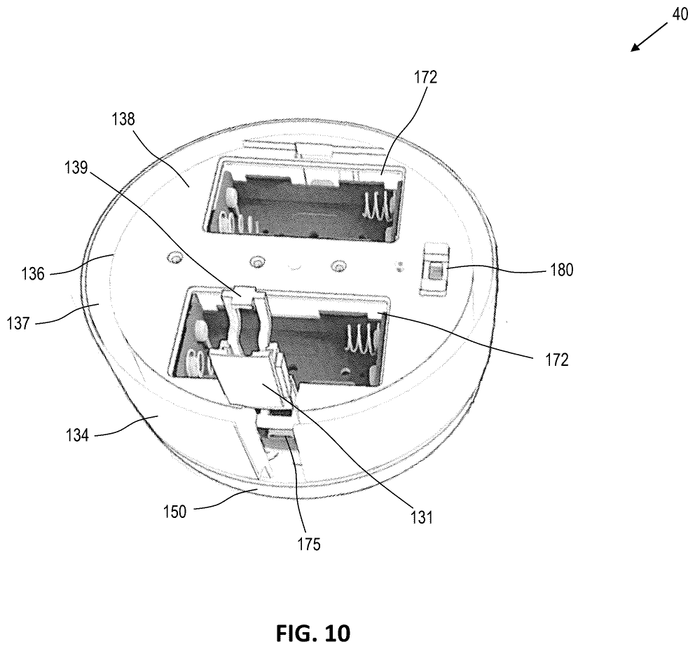

A bottom perspective view of the device assembly 40 with the bottom cover 140 removed is illustrated in FIG. 10. To remove the bottom cover 140, the flexible extension lever 137 may be moved from the locked position to an unlocked position. In the unlocked position the flexible extension lever 137 no longer engages the bottom cover 140. After the bottom cover 140 has been removed, the housing side panel 131 may be slid away from the housing 130 to expose the connector interface 174 that connects to the printed circuit board 170. The battery holders 172 may also be exposed with the bottom cover 140 removed. The on/off switch 180 may still be accessible on the underside of the device assembly 40 with the bottom cover 140 removed.

It is worth noting that device assemblies 40 may be configured with load cells 160 which may be appropriate for their expected use. For example, a device assembly 40 that may be configured with a load cell 160 which can accommodate higher weights, e.g., 4 kg, may not be suitable for use with lower weights, e.g., 100 grams. In such instances, the device assembly 40 may provide accurate weight information for the heavier weighted object but not necessarily provide such accurate results for the lower weighted object.

The selection of the appropriate load cell 160 to utilize within the device assemblies 40 is not a trivial task. For example, particularly where heavier weights are contemplated, the load cell 160 may be selected to provide accurate results when the weighted object is full and when it is near empty. At the near empty stage of use, the weighted object may lose a very large portion of its weight. In general, the load cell 160 may be selected having a sensitivity of not less than 10 grams plus or minus 5 grams. Sensitivity may be selected to go down to zero if needed. However, too sensitive of a load cell 160 can increase the likelihood of damage during use.

As the device assemblies 40 of the present disclosure are contemplated for use in wet environments, it is conceivable that some items may slip from a consumer's hands and impact the device assembly 40. Such impacts may damage the load cell 160 and/or negatively impact calibration of the load cell 160. In order to prevent catastrophic failure, one or more physical stops 167 (FIG. 7) may be utilized. The one or more physical stops 167 may limit the travel of the load cell 160 and ensure that it is not damaged.

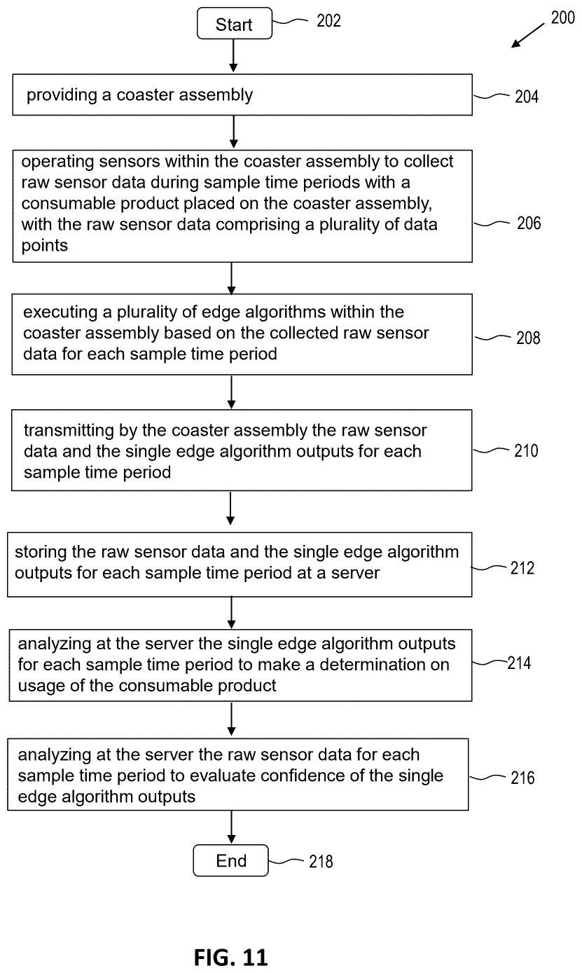

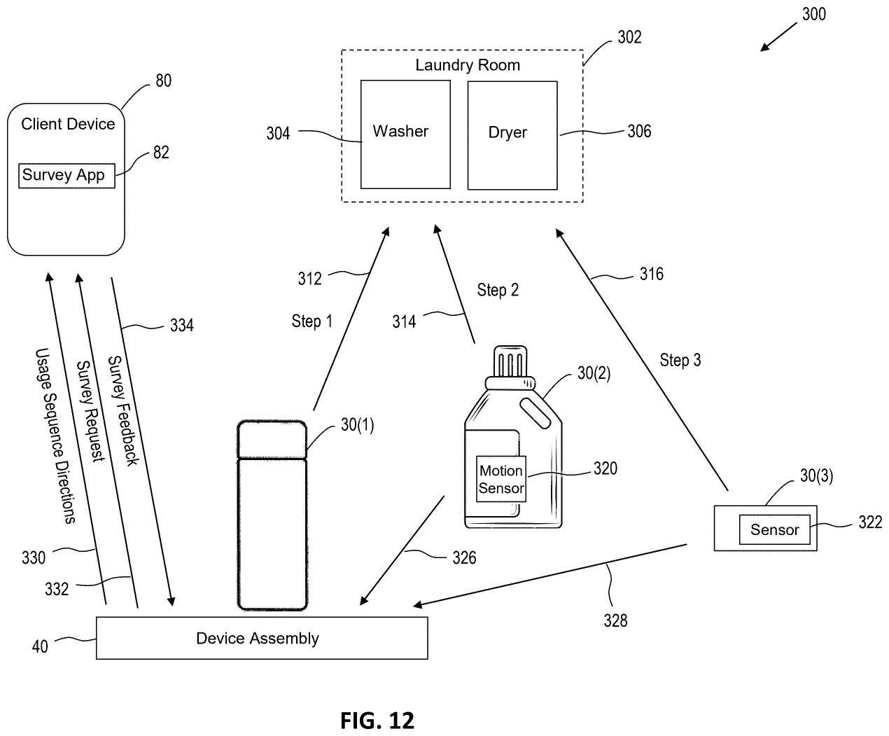

Another aspect may be directed to a method of determining usage of a consumable product 30 with the system 20. Referring now to the flowchart 200 in FIG. 11, from the start (Block 202), a device assembly 40 may be provided at Block 204. The device assembly 40 may be operated to collect raw sensor data 52 during sample time periods with a consumable product that may be placed thereon at Block 206, with the raw sensor data 52 comprising a plurality of data points within each sample time period for each sensor. A plurality of edge algorithms 46 may be executed at Block 208 based on the collected raw sensor data 52 for each sample time period. Each edge algorithm 46 may summarize the raw sensor data 52 from at least one of the sensors 42 as a single edge algorithm output 54. A communication module 56 within the device assembly 40 may transmit the raw sensor data 52 and the single edge algorithm outputs 54 for each sample time period. The method may further include operating the server 60 to store at Block 212 the raw sensor data 52 and the single edge algorithm outputs 54 for each sample time period. The single edge algorithm outputs 54 for each sample time period may be analyzed at Block 214 to make a determination on the usage of the consumable product 30. The raw sensor data 52 for each sample time period may be analyzed at Block 216 to evaluate confidence of the single edge algorithm outputs. The method ends at Block 218. Referring now to FIG. 12, a schematic diagram 300 of the system 20 may be configured to prompt a consumer on a recommended sequence of use of consumable products 30 will be discussed. Promptly after using the consumable products 30, this may allow the consumer to answer survey questions about their experience with the consumable products 30, where qualitative information may be obtained when consumer sentiment matches up with actual usage of the consumable products 30.

In the illustrated example, the consumable products 30 may be laundry products to be used in a certain sequence with a washer 304 and dryer 306 within a laundry room 302. In other examples, the consumable products 30 may be bath products, e.g., hair shampoo and conditioner, body wash, skin cleansers, personal grooming products, e.g., shave gels, creams, manual razors, electric razors, hair trimmers, post shave creams, gels, lotions, or cleaning products. The laundry products may include a bottle of laundry beads 30(1), laundry detergent 30(2) and a box of dryer sheets 30(3).

The laundry beads 30(1) may be scent boosters to give clothes a stronger, longer-lasting scent after washing. Laundry beads 30(1) may be placed in the washer 304 before clothes and water are added to the washer 304. After the clothes and water are in the washing machine 304, then the laundry detergent 30(2) may be added for washing. After the clothes have been washed, then the clothes may be placed in the dryer 306 along with a dryer sheet 30(3) to help to keep clothes from wrinkling in the dryer 406, and to soften, reduce static and repel lint. For best results, the laundry products 30 may be preferably used in a certain sequence.

After a bottle of the laundry beads 30(1) has been placed on a device assembly 40, the device assembly 40 may be ready to monitor the laundry beads 30(1). The device assembly 40 may detect when the bottle of laundry beads 30(1) is lifted off the device assembly 40. This may indicate that the laundry beads 30(1) are being used as indicated by step 1 310. The bottle of laundry beads 30(1) may then be returned to the device assembly 40. The device assembly 40 may send a first message as part of the usage sequence directions 330 to the survey app 82 in the client device 80. The usage sequence directions 330 may prompt the consumer to add laundry detergent 30(2) in the washer 304 along with the clothes.

It is worth noting that models may be developed and provided to the device assemblies 40 which allow for the device assemblies 40 to determine the type of product 30 that it is weighing. For example, via models, the device assemblies 40 may know that a laundry detergent bottle has been placed upon it or a laundry scent booster. Additionally, other configurations may be utilized. For example, RFID identification may be utilized so that the device assembly 40 may read the RFID of the product 30 being weighed. At step 2314, laundry detergent 30(2) may be added to the washer 304. The laundry detergent 30(2) may include a sensor 320 to send sensor data 326 to the device assembly 40 when the laundry detergent 30(2) is being moved. The sensor 320 may be a motion sensor that may detect movement of the laundry detergent 30(2), where movement may be used by the device assembly 40 to indicate usage of the laundry detergent 30(2).

After the device assembly 40 receives the sensor data 326 from the usage sensor 320, the device assembly 40 may send a second message as part of the usage sequence directions 330 to the survey app 82 in the client device 80. The usage sequence directions 330 may prompt the consumer to add one or more dryer sheets 30(3) to the dryer 306 along with the wet clothes. At step 3 316, a dryer sheet 30(3) may be added to the dryer 306.

The box of dryer sheets 30(3) may include a sensor 322, such as a time-of-flight sensor, which may be a tiny laser that emits infrared light. The time-of-flight sensor may be configured to measure a height of the dryer sheets 30(3) which may be used to determine usage of the dryer sheets 30(3). The device assembly 40 may receive sensor data 328 from the sensor 322 indicating usage of the dryer sheets 30(3).

The device assembly 40 may then send a survey request 332 to the survey app 82 in the client device 80. In response to the consumer answering the survey questions, the survey app 82 may provide survey feedback 334 back to the device assembly 40. The survey feedback 334 may provide qualitative information based on actual usage of the consumable products 30 in the correct sequence. The device assembly 40 may communicate the survey feedback 334 to the gateway 60 which may then be relayed to the cloud-based server 70. The device assembly 40 may also communicate the sensor data 326, 328 from sensors 320, 322 to the gateway 60 for analysis.

In addition, the washer 304 and the dryer 306 may use sensors to indicate time of cycle, duration and energy consumption of wash/dry sub-cycles. Collectively, this data may be analyzed in view of the sensor data provided by the device assembly 40 and the motion sensor data provided by the motion sensor 320 in the laundry detergent 30(2) to determine the criteria for a survey or notification to be sent to the consumer. For example, a determination may be made that more product was used on load 1 versus load 2. In this case, a survey or notification may be then sent to the consumer.

The bottle of laundry beads 30(1) may also have a motion sensor. As a possible scenario, the bottle of laundry beads 30(1) may get knocked over and is not returned to the device assembly within an expected time frame for a weight measurement. Then a different person doing laundry may not know that the consumer is doing a study, and this person may then pick up the tipped over bottle of laundry beads 30(1) to start a load of laundry. This person then may return the bottle of laundry beads 30(1) to the device assembly 40.

The sensor data that may be collected by the device assembly 40 is time stamped. The sensor data from the motion sensor in the bottle of laundry beads 30(1) may allow the device assembly 40 to determine that there was movement and possible usage of the bottle of laundry beads 30(1). The sensor data may also be used to explain why a weight measurement was not made within the expected timeframe due to the bottle of laundry beads 30(1) being tipped over. The next time the consumer does laundry, the device assembly 40 may detect a large weight change in the laundry beads 30(1). The sensor data may be combined with the other sensor data to develop a fuller picture on usage of the laundry products 30 or any other products which may be utilized in conjunction with the device assembly 40.

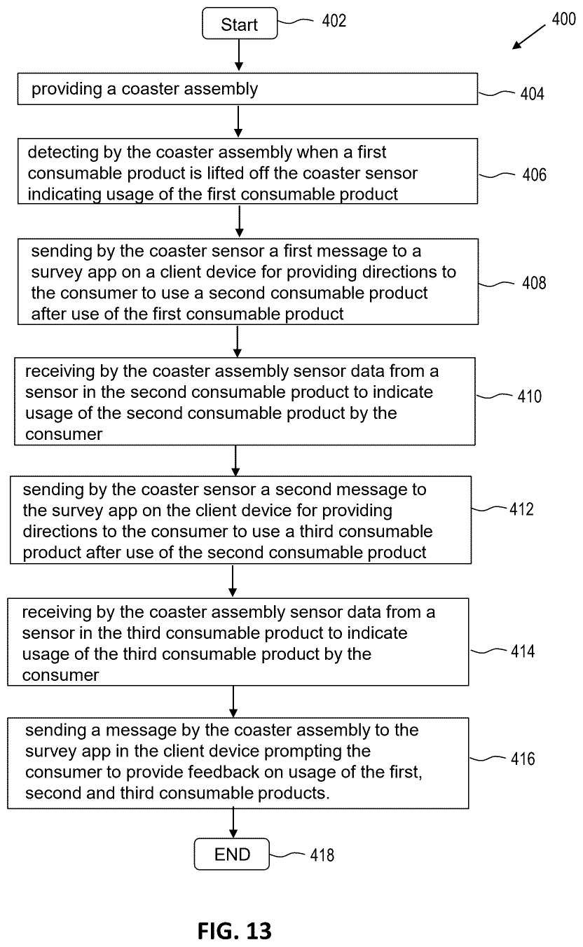

Another aspect may be directed to a method of prompting a consumer on a recommended sequence of use for a plurality of consumable products 30 based on the schematic diagram 300. Referring now to the flowchart 400 in FIG. 13, from the start (Block 402), the method may include placing a consumable product providing a device assembly 40 at Block 404. The device assembly 40 may detect at Block 406 when a first consumable product 30(1) is lifted off the device assembly 40 which may indicate usage of the first consumable product 30(1). The device assembly 40 may send at Block 408 a first message as part of the usage sequence directions 430 to a survey app 82 on a client device 80 which may provide directions to the consumer to use a second consumable product 30(2) after use of the first consumable product 30(1).

The device assembly 40 may receive at Block 410 sensor data 426 from a sensor 420 in the second consumable product 30(2) which may indicate usage of the second consumable product 30(2) by the consumer. The device assembly 40 may send a second message at Block 412 as part of the usage sequence directions 330 to the survey app 82 on the client device 80 for providing directions to the consumer to use a third consumable product 30(3) after use of the second consumable product 30(2).

The device assembly 40 may receive sensor data 328 at Block 414 from a sensor 322 in the third consumable product 30(3) which may indicate usage of the third consumable product 30(3) by the consumer. The device assembly 40 may send a survey request message 332 at Block 416 to the survey app 82 in the client device 80 which may prompt the consumer to provide survey feedback 334 on usage of the first, second and third consumable products 30. The method may end at Block 418.

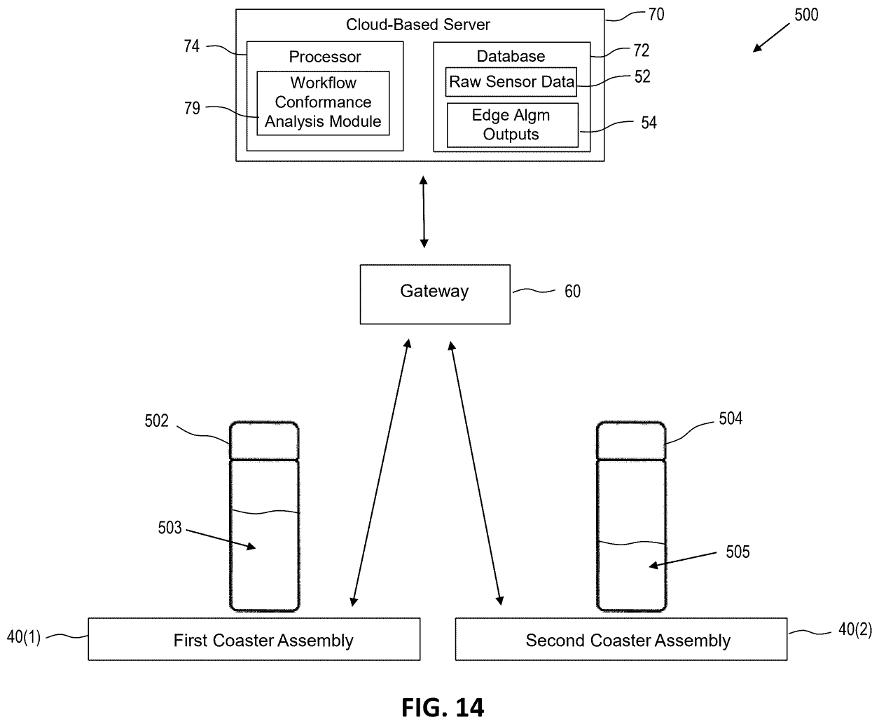

Referring now to FIG. 14, a schematic diagram 500 of the system 20 that may be configured to operate with a first device assembly 40(1) and a second device assembly 40(2) for detecting conformance with a recommended sequence of use for consumable products 503, 505 will be discussed.

A first consumable product package 502 may include the first consumable product 503, and a second consumable product package 504 that may include the second consumable product 503. The first and second consumable products 503, 505 may be laundry products, bath products or cleaning products, for example. For optimal consumer satisfaction, the first and second consumable products 503, 505 may be used in a recommended sequence.

The first consumable product package 502 may be placed on the first device assembly 40(1). Weight measurements that may be collected by the first device assembly 40(1) may be transmitted to the gateway 60 which then may transmit the weight measurements to the cloud-based server 70. The cloud-based server 70 may include a workflow conformance analysis module 79 that may be configured to calculate a first amount of the first consumable product 503 consumed during usage of the first consumable product 503. The workflow conformance analysis module 79 may compare the first amount to a first recommended usage amount for the first consumable product 502 which may produce a first usage amount comparison.

The second consumable product package 504 may be placed on the second device assembly 40(2). Weight measurements collected by the second device assembly 40(2) may be transmitted to the gateway 60 which then may transmit the weight measurements to the cloud-based server 70. The workflow conformance analysis module 79 in the cloud-based server 70 may be configured to calculate a second amount of the second consumable product 505 consumed during usage of the second consumable product 505. The workflow conformance analysis module 79 may compare the second amount to a second recommended usage amount for the second consumable product 504 to produce a second usage amount comparison.

The workflow conformance analysis module 79 may then compare a timestamp when the first consumable product package 502 is first used and a timestamp on when the second consumable product package 504 is first used to a recommended sequence and may produce a sequence comparison. A workflow conformance analysis that may include the first usage amount comparison, the second usage amount comparison, and the sequence comparison may be reported by the workflow conformance analysis module 79.

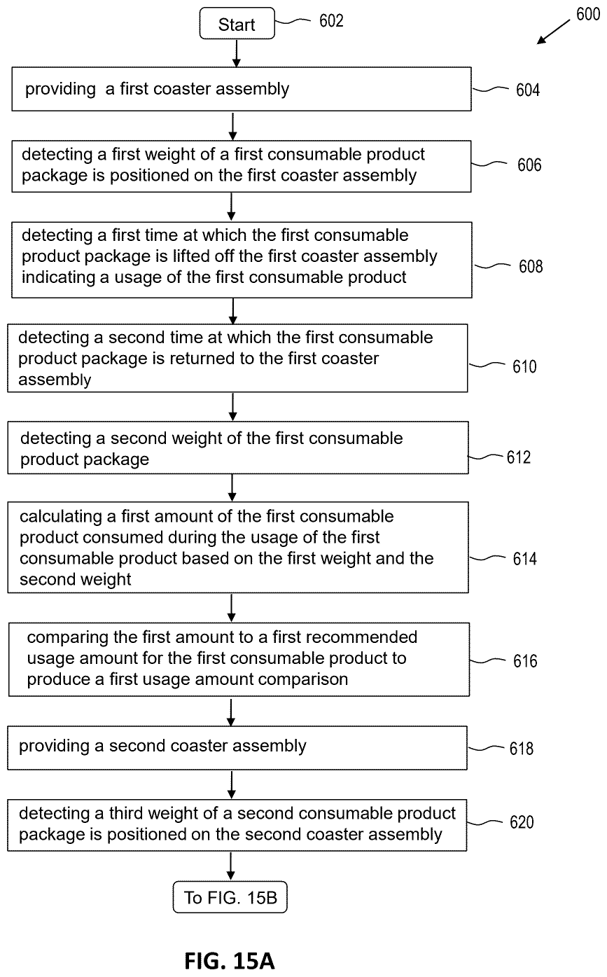

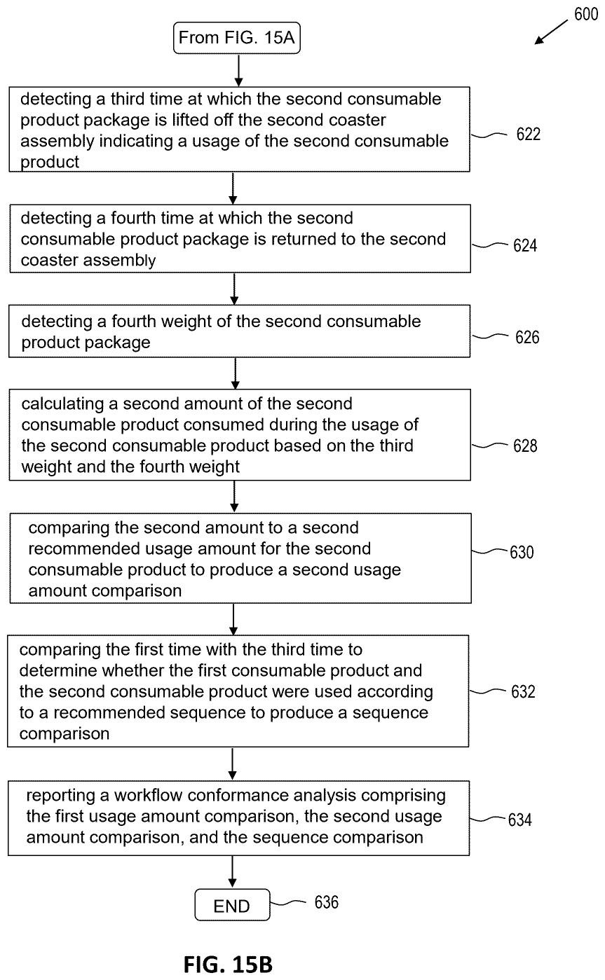

Another aspect may be directed to a method of detecting conformance with a recommended sequence of use for a plurality of consumable products 503, 505 that may be based on the schematic diagram 500. Referring now to the flowchart 600 in FIGS. 15A-15B, from the start (Block 602), the method may include providing a first device assembly 40(1) at Block 604. A first weight of a first consumable product package 502 may be detected at Block 606. The first consumable product package 502 may include a first consumable product 503 positioned on the first device assembly 40(1). A first time at which the first consumable product package 502 is lifted off the first device assembly 40(1) may be detected at Block 608 may indicate a usage of the first consumable product 503. A second time at which the first consumable product package 502 is returned to the first device assembly 40(1) may be detected at Block 610. A second weight of the first consumable product package 502 may be detected at Block 612. A first amount of the first consumable product 503 that may be consumed during the usage of the first consumable product 503 may be calculated at Block 614 based on the first weight and the second weight. The first amount may be compared to a first recommended usage amount for the first consumable product 503 at Block 616 to produce a first usage amount comparison.

A second device assembly 40(2) may be provided at Block 618. A third weight of a second consumable product package 504 may be detected at Block 620. The second consumable product package 504 may include a second consumable product 505 positioned on the second device assembly 40(2). A third time at which the second consumable product package 504 is lifted off the second device assembly 40(2) may be detected at Block 622 indicating a usage of the second consumable product 505. A fourth time at which the second consumable product package 504 is returned to the second device assembly 40(2) may be detected at Block 624. A fourth weight of the second consumable product package 504 may be detected at Block 626. A second amount of the second consumable product 505 consumed during the usage of the second consumable product 505 may be calculated at Block 628 based on the third weight and the fourth weight. The second amount may be compared at Block 630 to a second recommended usage amount for the second consumable product 505 to produce a second usage amount comparison.

The first time may be compared with the third time at Block 632 to determine whether the first consumable product 503 and the second consumable product 505 were used according to a recommended sequence to produce a sequence comparison. A workflow conformance analysis that may include the first usage amount comparison, the second usage amount comparison, and the sequence comparison may be reported at Block 634. The method may end at Block 636.

### ADDITIONAL EXAMPLES/COMBINATIONS

Example A: A device assembly comprising:
a housing having upper and lower edge sections with a transition section therebetween, and with the upper edge section being recessed from the lower edge section;
a bottom cover coupled to an underside of the housing;
a top plate extends over a topside of the housing and overhangs a portion of the transition section of the housing, with the top plate to receive a consumable product and being movable with respect to the housing;
a weight sensor positioned within an interior of the housing and contacting the top plate for collecting weight measurements during sample time periods;
a controller coupled to the weight sensor and configured to execute at least one edge algorithm based on the collected weight measurements for each sample time period, with the at least one edge algorithm summarizing the weight measurements as a single edge algorithm output for each sample time period; and
a communication module coupled to the controller and configured to transmit the single edge algorithm output for each sample time period.

Example A1: A device assembly comprising:
a housing comprising an upper surface configured to receive a consumable product placed thereon;
a weight sensor positioned within an interior of the housing and configured to collect weight measurements during sample time periods;
at least one additional sensor within an interior of the housing and configured to collect raw sensor data during sample time periods, with the raw sensor data comprising a plurality of data points within each sample time period for each sensor;
a controller coupled to the weight sensor and the at least one additional sensor, and configured to execute a plurality of edge algorithms based on the collected raw sensor data for each sample time period, with each edge algorithm summarizing the raw sensor data from at least one of the sensors as a single edge algorithm output; and
a communication module coupled to the controller and configured to transmit the raw sensor data and the single edge algorithm outputs for each sample time period.

Example A2: The device assembly according to any of Examples A and A1, wherein the weight sensor comprises a load cell assembly.

Example A3: The device assembly according to any of Examples A-A2, wherein the communication module is configured as a Bluetooth communication module to transmit the raw sensor data and the single edge algorithm outputs to a gateway which then relays the raw sensor data and the single edge algorithm outputs to a cloud-based server.

Example A4: The device assembly according to any of Examples A-A3, wherein the communication module is configured as a cellular communication module to transmit the raw sensor data and the edge algorithm outputs to a cloud-based server.

Example A5: The device assembly according to any of Examples A-A4, wherein the communication module is configured to receive updates from a cloud-based server for the plurality of edge algorithms.

Example A6: The device assembly according to any of Examples A-A5, wherein the communication module is further configured to transmit the collected weight measurements with the single edge algorithm outputs.

Example A7: The device assembly according to any of Examples A-A6, wherein the load cell assembly comprises: a load cell; a load plate coupled to an upper surface of the load cell; and a bottom plate coupled to an underside of the load cell.

Example A8: The device assembly according to any of Examples A-A7, wherein the top plate is spring-loaded with respect to the weight sensor.

Example A9: The device assembly according to any of Examples A-A8, further comprising a switch between the weight sensor and the top plate, with the switch comprising an arm contacting an underside of the top plate.

Example A10: The device assembly according to any of Examples A-A9, wherein the switch is activated when the consumable product is removed from the top plate and the top plate no longer makes contact with the arm of the switch.

Example A11: The device assembly according to any of Examples A-A10, wherein a side edge of the top plate is recessed from the lower edge section of the housing.

Example A12: The device assembly according to any of Examples A-A11, wherein the communication module is configured as a Bluetooth communication module to transmit the single edge algorithm outputs to a gateway which then relays the single edge algorithm outputs to a cloud-based server.

Example A13: The device assembly according to any of Examples A-A12, wherein the communication module is configured as a cellular communication module to transmit the single edge algorithm outputs to a cloud-based server.

Example A14: The device assembly according to any of Examples A-A13, wherein the communication module is configured to receive updates from a cloud-based server for the at least one edge algorithm.

Example A15: The device assembly according to any of Examples A-A14, wherein the communication module is configured to receive at least one of firmware updates, cloud functions, time close updates.

Example B: A method of determining usage of a consumable product comprising:
providing a device assembly;
operating the device assembly with a consumable product placed thereon to perform the following:
collect raw sensor data during sample time periods, with the raw sensor data comprising a plurality of data points within each sample time period for each sensor,
execute a plurality of edge algorithms based on the collected raw sensor data for each sample time period, with each edge algorithm summarizing the raw sensor data from at least one of the sensors as a single edge algorithm output, and
transmit the raw sensor data and the single edge algorithm outputs for each sample time period; and
operating a server to perform the following:
store the raw sensor data and the single edge algorithm outputs for each sample time period,
analyze the single edge algorithm outputs for each sample time period to make a determination on the usage of the consumable product, and
analyze the raw sensor data for each sample time period to evaluate confidence of the single edge algorithm outputs.

Example B1: A method for prompting a consumer on a recommended sequence of use for a plurality of consumable products comprising:
providing a device assembly;
detecting by the device assembly when a first consumable product is lifted off the device assembly indicating usage of the first consumable product;
sending by the device assembly a first message to a survey app on a client device for providing directions to the consumer to use a second consumable product after use of the first consumable product;
receiving by the device assembly sensor data from a sensor in the second consumable product to indicate usage of the second consumable product by the consumer;
sending by the device assembly a second message to the survey app on the client device for providing directions to the consumer to use a third consumable product after use of the second consumable product;
receiving by the device assembly sensor data from a sensor in the third consumable product to indicate usage of the third consumable product by the consumer; and
sending a message by the device assembly to the survey app in the client device prompting the consumer to provide feedback on usage of the first, second and third consumable products.

Example B2: A method for detecting conformance with a recommended sequence of use for a plurality of consumable products, the method comprising:
providing a first device assembly;
detecting a first weight of a first consumable product package, the first consumable product package comprising a first consumable product and positioned on the first device assembly;
detecting a first time at which the first consumable product package is lifted off the first device assembly indicating a usage of the first consumable product;
detecting a second time at which the first consumable product package is returned to the first device assembly;
detecting a second weight of the first consumable product package;
calculating a first amount of the first consumable product consumed during the usage of the first consumable product based on the first weight and the second weight;
comparing the first amount to a first recommended usage amount for the first consumable product to produce a first usage amount comparison;
providing a second device assembly;
detecting a third weight of a second consumable product package, the second consumable product package comprising a second consumable product and positioned on the second device assembly;
detecting a third time at which the second consumable product package is lifted off the second device assembly indicating a usage of the second consumable product;
detecting a fourth time at which the second consumable product package is returned to the second device assembly;
detecting a fourth weight of the second consumable product package;
calculating a second amount of the second consumable product consumed during the usage of the second consumable product based on the third weight and the fourth weight;
comparing the second amount to a second recommended usage amount for the second consumable product to produce a second usage amount comparison;
comparing the first time with the third time to determine whether the first consumable product and the second consumable product were used according to a recommended sequence to produce a sequence comparison; and
reporting a workflow conformance analysis comprising the first usage amount comparison, the second usage amount comparison, and the sequence comparison.

Example B3: The method according to any of Examples B-B2, wherein the device assembly comprises at least one of a weight sensor, a temperature sensor and a battery sensor, wherein the raw sensor data collected by the temperature sensor and the battery sensor are used as indicators by the plurality of edge algorithms to determine if the raw sensor data collected by the weight sensor is to be discarded.

Example B4: The method according to any of Examples B-B3, wherein the plurality of edge algorithms comprises at least one secondary edge algorithm to assess statistical variances of the raw sensor data to determine if an error code is to be generated to create awareness of a problem.

Example B5: The method according to any of Examples B-B4, wherein each edge algorithm is configured to perform a mathematical calculation on the raw sensor data received for each sample time period to generate one of the single edge algorithm outputs.

Example B6: The method according to any of Examples B-B5, further comprising sending updates by the server to the plurality of edge algorithms based on the analyzed raw sensor data to improve confidence of the single edge algorithm outputs.

Example B7: The method according to any of Examples B-B6, further comprising communicating by the device assembly to a client device comprising a survey app including pre-deployed survey questions, with the pre-deployed survey questions being triggered by the device assembly in response to at least one of the edge algorithm outputs satisfying specific criteria, such as a weight change in the consumable product.

Example B8: The method according to Example B7, wherein the survey app includes pre-deployed survey questions to generate the feedback, with the pre-deployed survey questions being triggered by the message received from the device assembly.

Example B9: The method according to Example B8, wherein the feedback from the consumer is received by the device assembly, and further comprising the device assembly forwarding the feedback to a server for processing.

Example B10: The method according to any of Examples B-B9, wherein the device assembly generates time stamps corresponding to when the first, second and third consumable products are used.

Example B11: The method according to Examples B2-B10, wherein the first, second and third consumable products comprise at least one of laundry products, bath products and cleaning products.

Example B12: The method of any of Examples B2-B11, further comprising sending a survey to a consumer of the first and second consumable products, with the consumer taking the survey.

Example B13: The method of any of Examples B2-B12, further comprising associating a level of consumer satisfaction indicated in the survey with the workflow conformance analysis.

Example B14: The method of any of Examples B2-B13, wherein the first device assembly associates time stamps with usage of the first consumable product, and the second device assembly associates time stamps with usage of the second consumable product, with the time steps being included in the workflow conformance analysis.

Example B15: The method of any of Examples B2-B14, further comprising: communicating by the first device assembly the detected first and second weights to a server, wherein the server performs the calculating of the first amount of the first consumable product consumed and produces the first usage amount comparison;
communicating by the second device assembly the detected third and fourth weights to the server, wherein the server performs the calculating of the second amount of the first consumable product consumed and produces the second usage amount comparison; and wherein the server produces the workflow conformance analysis

Example B16: The method of any of Examples B2-B15, wherein the first and second consumable products comprise at least one of laundry products, bath products and cleaning products.

Example B17: The method of any of Examples B-B16, wherein data from the temperatures sensor are utilized to calibrate the weight sensor.

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for determining usage of a consumable product comprising:
a device assembly configured to receive the consumable product when placed thereon, the device comprising:
one or more sensors configured to collect raw sensor data during sample time periods, with the raw sensor data comprising a plurality of data points within each of the sample time periods for each sensor,
a controller coupled to the one or more sensors and configured to execute a plurality of edge algorithms based on the collected raw sensor data for each of the sample time periods, with each edge algorithm summarizing the raw sensor data from at least one of the one or more sensors as a single edge algorithm output, and
a communication module coupled to the controller and configured to transmit the raw sensor data and the single edge algorithm outputs for each sample time period; and
a server comprising:
a memory configured to store the raw sensor data and the single edge algorithm outputs for each sample time period, and
a processor coupled to the memory and configured to perform the following:
make a determination on the usage of the consumable product based on the single edge algorithm outputs for each sample time period, and
analyze the raw sensor data for each sample time period to evaluate confidence of the single edge algorithm outputs.

2. The system according to claim 1, wherein the device assembly further comprises a power source, and the one or more sensors comprises at least one of a weight sensor, a temperature sensor, or a battery sensor.

3. The system according to claim 2, wherein the power source comprises at least one of: a replaceable battery, a rechargeable battery, or a power cord with a plug.

4. The system according to claim 3, wherein the device assembly further comprises an antenna and charges the rechargeable battery via capturing radio frequency signals from an ambient environment.

5. The system according to claim 1, wherein the one or more sensors comprises a weight sensor, a temperature sensor, and a battery sensor, and wherein the raw sensor data collected by the temperature sensor and the battery sensor are used as indicators by the plurality of edge algorithms to determine if the raw sensor data collected by the weight sensor is to be discarded.

6. The system according to claim 1, wherein the plurality of edge algorithms comprises at least one secondary edge algorithm to assess statistical variances of the raw sensor data to determine if an error code is to be generated to create awareness of a problem.

7. The system according to claim 1, wherein each edge algorithm is configured to perform a mathematical calculation on the raw sensor data received for each sample time period to generate at least one of the single edge algorithm outputs.

8. The system according to claim 7, wherein the mathematical calculation comprises at least one of determining a delta from a previous measurement, an average of measurements during the sample time period, and a sigma average that is a standard deviation of a last measurement.

9. The system according to claim 1, wherein the plurality of edge algorithms comprises at least one of the following:
a weight delta analysis model to determine a change in weight of the consumable product from a previous measurement;
a weight average model to determine an average of the weight measurements during each sample time period;
a sigma weight average model to determine a standard deviation of a last measurement; or
a tare weight model to determine a weight value when the consumable product is removed from the device assembly.

10. The system according to claim 1, wherein the one or more sensors comprises a motion sensor, and wherein the plurality of edge algorithms further comprises a motion threshold model to determine if a motion limit value of the device assembly has been exceeded.

11. The system according to claim 1, wherein the server is configured to send updates to the plurality of edge algorithms based on the analyzed raw sensor data to improve confidence of the single edge algorithm outputs.

12. The system according to claim 11, wherein the device assembly comprises at least one memory with first and second memory sections, with the first memory sections to store the plurality of edge algorithms and the second memory sections to store the updated plurality of edge algorithms, and wherein the controller is further configured to verify operation of the plurality of updated edge algorithms in the second memory sections before using the updated edge algorithms.

13. The system according to claim 1, further comprising a gateway configured to perform the following:
receive the raw sensor data and the single edge algorithm outputs from the device assembly; and
transmit the received raw sensor data and the single edge algorithm outputs to the server.

14. The system according to claim 1, wherein the device assembly further comprises a communication module configured to transmit the raw sensor data and the single edge algorithm outputs directly to the server.

15. The system according to claim 1, wherein the device assembly is further configured to communicate with a client device comprising a survey app including pre-deployed survey questions, with the pre-deployed survey questions being triggered by the device assembly in response to at least one of the edge algorithm outputs satisfying specific criteria.

16. The system according to claim 15, wherein the specific criteria comprises a weight change in the consumable product.

17. The system according to claim 1, wherein the server is further configured to transmit at least one survey question to a client device in response to at least one of the edge algorithm outputs satisfying specific criteria.

18. The system according to claim 17, wherein the specific criteria comprises a weight change in the consumable product.

19. The system according to claim 1, wherein the device assembly further comprises a top plate forming a top surface and a load plate positioned subjacent to the top plate and a switch positioned between the top plate and the load plate, wherein the switch is configured to detect a placement and removal of the consumable product from the top surface.
